(19) United States
(12) Patent Application Publication
(10) Pub. No.: US 2015/0339009 A1
(43) Pub. Date: Nov. 26, 2015

(54) PROVIDING DYNAMIC CONTENTS USING WIDGETS

(71) Applicant: ADRRA CO., LTD., Seoul (KR)

(72) Inventor: Jang Won Seo, Seoul (KR)

(21) Appl. No.: 14/724,566

(22) Filed: May 28, 2015

Related U.S. Application Data
(63) Continuation-in-part of application No. PCT/KR2013/010884, filed on Nov. 28, 2013.

(30) Foreign Application Priority Data
Nov. 29, 2012 (KR) 10-2012-0137005
Nov. 29, 2012 (KR) 10-2012-0137006

(51) Int. Cl. G06F 3/0482; H04L 29/08; G06F 3/0484

(52) U.S. Cl. CPC G06F 3/0482; G06F 3/04842; H04L 67/02

(57) ABSTRACT

The present invention pertains to a method for providing different contents in correspondence to visibly changed widget on a smart device screen. The method includes (a) displaying a changing widget visibly changed on a user screen of a smart device, (b) selecting, by an input unit of the smart device, the changing widget, and (c) calling content corresponding to the selected changing widget to the user screen of the smart device.

### PRIORITY CLAIMS AND CROSS-REFERENCE TO RELATED APPLICATION

This patent document is a continuation-in-part application of, and claims priority and benefits of, a Patent Cooperation Treaty (PCT) application number PCT/KR2013/010884 entitled “METHOD FOR PROVIDING DIFFERENT CONTENT ACCORDING TO WIDGET TO BE VISUALLY CHANGED ON SCREEN OF SMART DEVICE” and filed with the Korean Intellectual Property Office (KIPO) on Nov. 28, 2013, which further claims priority and the benefits of Korean Patent Application Nos. 10-2012-0137005 and 10-2012-0137006 filed on Nov. 29, 2012. The entire disclosures of the above applications are incorporated by reference as part of this document.

### TECHNICAL FIELD

This patent document relates to a method for providing content by using a user device such as a smart device, and more particularly, to a method and system for providing content by using a widget installed in a user device such as a smart device.

### BACKGROUND

Today, a wide variety of content is being distributed through various systems and devices. The content distribution has traditionally been activated by using the Internet. A pivotal hardware element is a PC. However, with the distribution of smart phones and tablet PCs, and development of software technology, content distribution through mobile devices becomes gradually important.

As the market of smartphones and tablet PCs occupies the center of the mobile industry, a typical feature phone-oriented mobile communication service becomes faced a big change. A smart phone does not simply function as a mobile phone, but also functions as a small computer in a hand and various functions never seen before are implemented. In addition, a new service provision is possible.

Furthermore, a user device has lots of functions but various designs for a user interface are required due to a small screen. Various icons that perform different functions are arranged on a screen. For example, some icons are provided to call an application software installed in a user device and execute a function of the application software. Some icons are provided to call and execute software for setting an operating system. Some icons are provided to function as a kind of widget and execute an access to a specific content without using a browser.

Use of mobile content or popularity of a specific application depends on how often a user selects and executes an icon or widget. Given that various and many icons and widgets are installed in a user device, there exist some limitations to get user's interest. In addition, since the icons and widgets exist as images whose forms are fixed on a display screen, there is no effective way to get user's “attraction” other than “image differentiation.”

Generally, mobile content has been distributed through two methods, i.e., pushing method and pulling method. The pushing method allows an application server to provide content by pushing the content to a device. This pushing method is mostly performed through an e-mail communication, a transmission of a message including a link, or a transmission using a specific application screen executed in the device. However, since content is pushed by the application server instead of the user, content provided by the pushing method may be recognized as spam and give a user an unpleasant feeling.

The pulling method allows a user to access to content. Since content is provided by user's selection, the pulling method does not cause user's unpleasant feeling. However, since the content needs to be spontaneously selected by the user among lots of contents, there is a limitation for content to be widely distributed.

### SUMMARY

Various implementations of the disclosed technology provide a graphic user interface inducing user's interest and causing a selection event for content and a system obtaining or calling various contents by using such a graphic user interface.

Some of the implementations of the disclosed technology can greatly improve user's access to content and content distribution possibility by using a graphic user interface which is suggested to provide the content.

Some of the implementations of the disclosed technology provide a user device for interworking with the graphic user interface suggested in this patent document.

In one aspect, a method for providing content is provided. The method comprises: (a) displaying a changing widget on a display unit of a user device, the changing widget being changeable on the display as one of different widgets including a first widget and a second widget that are visually different from one another; (b) receiving, by an input unit of the user device, an input indicating a selection of one of the different widgets as a selected widget; and (c) displaying content corresponding to the selected widget on the display unit of the user device.

In some implementations, the different widgets are visually different from one another in at least one of a form, color, or a position of the widgets.

In some implementations, the user device includes a smartphone, and the changing widget is displayed on a lock release screen of the display unit.

In some implementations, the user device includes a smartphone, and the changing widget is displayed on a home screen of the display unit.

In some implementations, the displayed content changes based at least on the selected widget.

In some implementations, the first widget and the second widget are associated with different contents from each other.

In some implementations, the displayed content includes a mobile coupon, an information page, advertisement content, or gift content.

In some implementations, the method further comprises: (d) determining whether the displayed content is associated with a reward event and if the obtained content is associated with the reward event, performing the reward event for the user device.

In some implementations, the user device includes a smartphone, tablet PC, or smart TV.

In another aspect, it is provided a non-transitory computer readable medium storing instructions when executed by a computing device that enable operations comprising: displaying a changing widget on a display unit of a user device, the changing widget being changeable on the display as one of different widgets including a first widget and a second widget that are visually different from each other; receiving, at an input unit of the user device, an input indicating a selection of one of the different widgets as a selected widget; and displaying content corresponding to the selected widget on the display unit of the user device.

In another aspect, a server providing different contents associated with a changing widget is provided. The server comprises: an application unit providing a changing widget to a user device, the changing widget having a visual appearance changeable as one of different widgets that are different from one another; a database storing information on the user device and contents associated with the respective different widgets; and a control unit receiving a request for content from the user device and transmitting, in responsive to the request, content selected from the stored contents in the database to the user device, wherein the received request is associated with a selected widget displayed on the user device and the transmitted content is associated with the selected widget.

In some implementations, the different widgets are different in terms of at least one of a form, color, or a position of the widgets.

In some implementations, wherein the content includes a mobile coupon, an information page, advertisement content, gift content, or a message.

In some implementations, the server further comprises an advertisement content server configured to provide a reward in response to the request for content from the user device.

In some implementations, the user device includes a smartphone, tablet PC, or smart TV.

In another aspect, an user device providing different contents is provided to comprise: a processor to execute a changing widget application providing a changing widget and controlling a visual appearance of the changing widget as the changing widget changes among different widgets; a data storage unit configured to store information associated with the different widgets changeable by the changing widget and information associated with contents corresponding to the different widgets; an communication unit configured to receive a selection signal for a particular widget among the different widgets of the changing widget; and a display unit configured to display the corresponding contents to the particular widget.

In some implementations, the different widgets are different in terms of at least one of a form, color, or a position of the widgets.

In some implementations, the content includes a mobile coupon, an information page, advertisement content, gift content, or a message.

In some implementations, the processor communicatively operates with external servers providing contents.

In some implementations, the user device includes a smartphone, tablet PC, or smart TV.

### BRIEF DESCRIPTION OF DRAWINGS

FIG. 1 is a schematic view of an exemplary system of one implementation of the disclosed technology;

FIG. 2 is an exemplary block diagram of a user device included in the system according to one implementation of the disclosed technology;

FIG. 3 is a view conceptually illustrating changes of a changing widget;

FIGS. 4A and 4B are views illustrating exemplary screens displaying a changing widget;

FIGS. 5A to 5E are views illustrating exemplary visible changes of a changing widget according to various implementations of the present invention;

FIG. 6 is a view conceptually explaining a relationship between a changing widget and content displayed on a user device;

FIG. 7 is a view exemplarily illustrating changes of content in response to a selection for a changing widget; and

FIG. 8 is a flow chart schematically illustrating a process providing different contents according to an implementation of the disclosed technology.

The accompanying drawings are provided to facilitate the understanding of some implementations of the disclosed technology. Such drawings provide examples of various implementations only and the scope of the disclosed technology is not limited thereby.

### DETAILED DESCRIPTION

In a mobile environment, it is important to respect user's experience and give a user pleasure. If content is pushed for a short-term effect, if it causes a user's unpleasant feeling, content cannot be continuously distributed. In that sense, a pulling method typed content may be more desired. Implementations of this patent document propose an improved pulling method. Some implementations of the suggested pulling method may provide a tool inducing a user's spontaneous selection.

To suggest an improved pulling method, a psychological behavior of a user has been studied. Since there is a psychological reason for user's behaviors, it is believed that a certain psychological factor can lead a user to execute an event in a device. In addition, it is analyzed that a series of user's behaviors in a device environment are originated from any one of (1) interest originated from curiosity, (2) expectation for a new event, and (3) expectation for economical compensation. Some implementation of the disclosed technology are suggested by associating the user's behavior with pulling typed content distribution.

Hereinafter, various implementations of the disclosed technology will be described in detail with reference to accompanying drawings.

“Widget” includes graphic user interface (GUI) components including an icon, badge, or widget displayed on display screen of a user device. If selected by an input unit, the GUI components executes an application to provide content or execute a web browser to provide content. For example, icons displayed on a home screen of a smartphone are all included as “widget” in this patent document.

In this patent document, some widgets can be changed in terms of a form, color and/or position according to a pre-determined schedule or randomly on a display screen of a user device. Such widget that has a changing feature is referred to as “changing widget.”

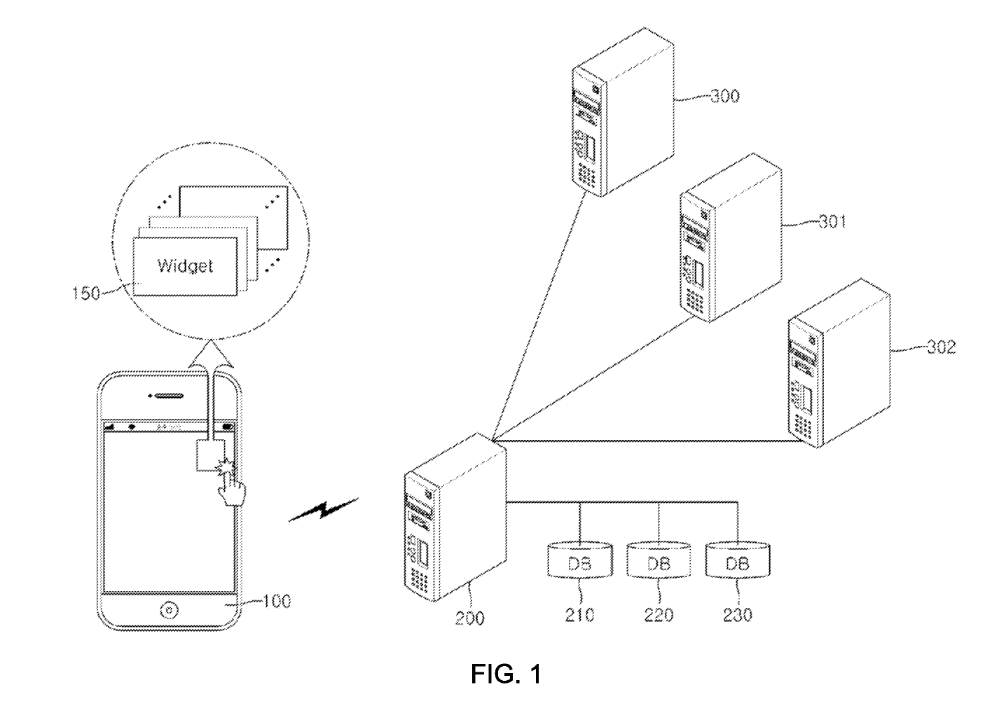

FIG. 1 illustrates a schematic view of an exemplary system according to one implementation of the disclosed technology. A widget 150 is installed at a certain area on a display screen of a user device 100 as a changing widget 150 which changes a form, color, and/or position thereof on a display screen according to a determined rule or randomly. An application server 200 provides the changing widget 150 and interworks with a plurality of databases. The database 210 may record information on a user device in which the changing widget 150 is installed. The database 220 may record a history of a selection event for the changing widget 150 of the user device 100. The database 230 may store and manage contents 230 provided to the user device 100 according to execution of the changing widget 150. Although not shown in the drawing, in some implementations, a database in which content provider servers 300, 301, and 302 providing content are recorded, and a database in which a user reward or charging information is recorded may be further included. In addition, the application server 200 manages a changing widget installed in a user device and updates data, if necessary. In some implementations, the application server 200 additionally adds a function to the widget or deletes an installed function.

The user device 100 accesses the application server 200 and installs a changing widget application therein. When a selection event such as a touch of the changing widget 150 with an input unit occurs, it is determined which content is displayed on a device screen. In some implementations, the content corresponding to the changing event of the changing widget 150 may be executed by accessing the application server 200. In some implementations, the application server 200 records only a content history and the device 100 directly accesses sites of the content provider servers 300, 301, and 302 providing contents to execute content.

The content provider servers 300, 301, and 302 may pre-register content with the application server 200. The content may be directly registered in the application server 200, or a link to the contents may be registered.

The content herein may include text, image, or sound, or a combination of any two of text, image, and sound. The content may include an access web pages provided by the content provider server 300, 301, and 302. The content may include video content. In some implementations, the content may include data or a medium having certain information. For example, such information may include a coupon or ticket.

A communication system may use a wireless communication network. The wireless communication network includes a mobile communication network such as 3G or LTE, or a wireless internet such as a WiFi internet. In some implementations of the disclosed technology, the user device includes the smart device that is a computing device. The user device may include a mobile computing device such as a smartphone or tablet PC and a smart TV interoperating with a smartphone or tablet PC.

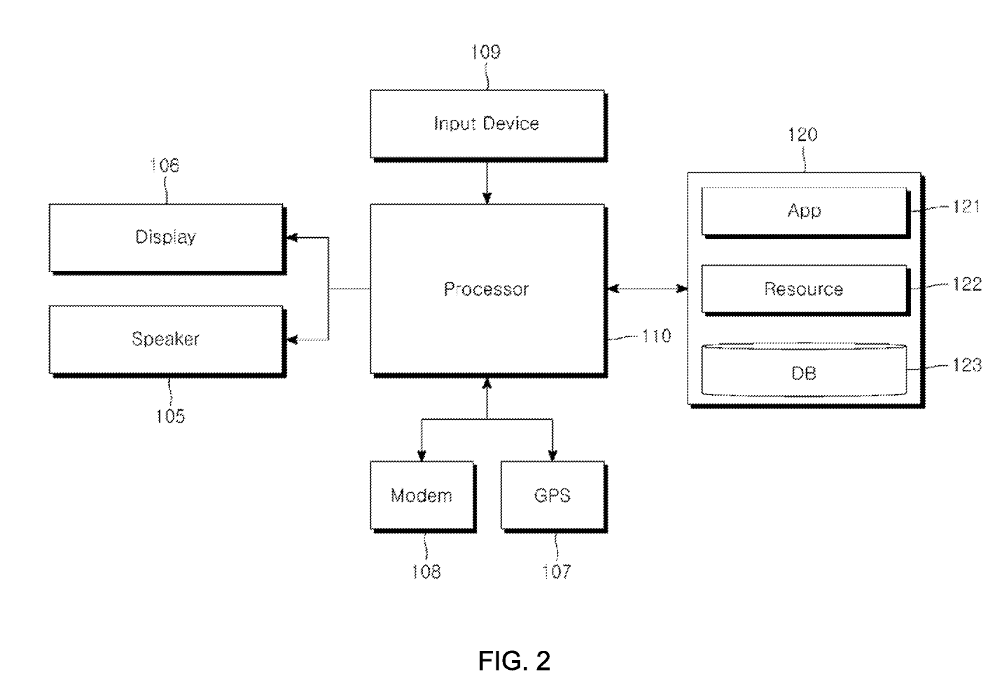

FIG. 2 schematically illustrates an block diagram of an exemplary user device according to one implementation of the disclosed technology. An input device 109 receives an input event executed by an input unit. The input unit 109 in the smartphone or the tablet PC includes a touch screen and delivers a touch event to a processor. The input unit 109 of the smart TV may use an input unit of the smart phone or tablet PC, which interoperates therewith. In addition, the input unit 109 of the smart TV may include a remote controller communicating wirelessly or a mouse executing a remote control function.

A communication module 108 plays a role for transmitting and receiving data to and from an external device. Various transmission and reception events that are caused by the changing widget are processed through the communication module 108. In addition, a GPS module 107 may be included in the user device. A processor 110 controls processing of processes relating to installation, display, and execution of the changing widget and performs a control so that a change of the changing widget is guaranteed by operating system software and executed by application software.

The internal memory 120 of the user device generally provides a place in which a computer code and data used in the device are stored. In addition, the internal memory 120 may store a changing widget application 121, a resource 122 necessary for executing and managing the changing widget, and a database storing various histories and downloaded content according to execution of the changing widget. In some implementations of the disclosed technology, content called by the changing widget may include content stored in the internal memory 120 of the device. In some implementations of the disclosed technology, content called by the changing widget may include content stored in a database of an external server, for example, the application server 200 or the content provider server 300, 301, and 302.

The processor 110 executes an operation that executes a computer code, and creates and uses data together with an operating system. In addition, the processor 110 may receive and process input and output data between components of the smart device by using a series of instructions. In addition, the processor 110 functions as a controller executing a function of application software installed in the user device. In some implementations, the processor 110 executes the changing widget application installed in the user device and visibly changes the changing widget on the user screen of the display. In addition, when an input unit generates a selection event for the changing widget, the processor 110 obtains the content corresponding to the changing widget selected in response to the corresponding selection event and display the obtained content on a user screen of the display.

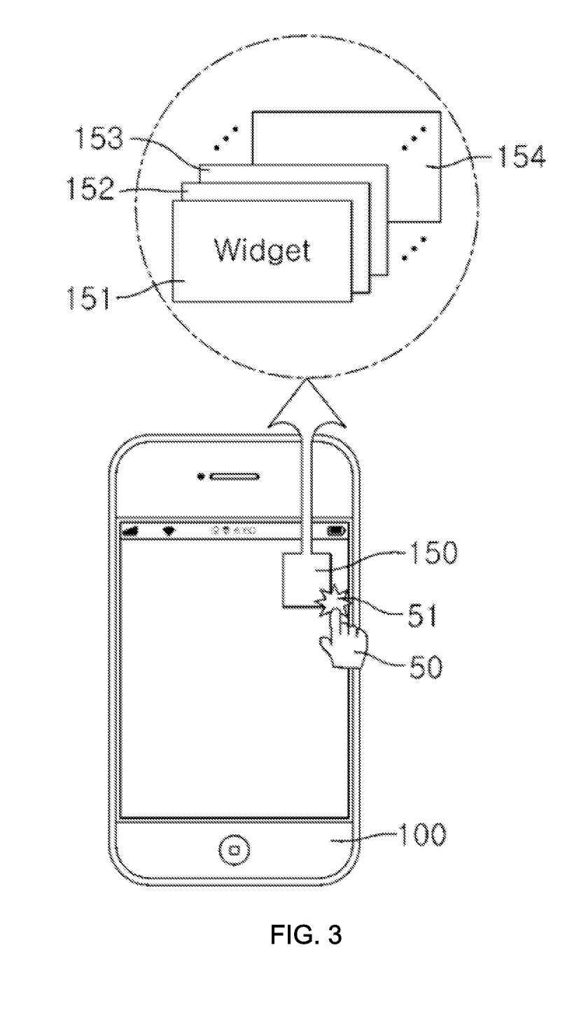

The display 106 and a speaker 105 of the user device provide output from the user device. The changing widget is disposed in a certain layer on a user interface of the display 106. FIG. 3 is a view conceptually illustrating various changes of the changing widget 150 in an embodiment of the disclosed technology. The changing widget 150 is displayed on a screen of the user device 100. The changing widget 150 will change a form, color, and/or position at a predetermined time interval or randomly according to a rule set by the application server. In other words, the widget 150 is installed on the device screen and the widget 150 may be changed to a widget 1 151, widget 2 152, widget 3 153, and widget N 154 according to a changing event.

The selection event may occur by, for example, making a touch point 51 on any one widget associated with the changing widget 150. For example, let's assume that the changing widget 150 is changed to the widget 1 151 and the selection event occurs at that time. Then, content corresponding to the widget 1 151 is displayed on the device and contents corresponding to other widgets are not displayed. In this case, although the user may know that the changing widget 150 has a changing feature, since the user does not know which content is hidden, the user's curiosity can be induced and the user's interest for the content can be increased.

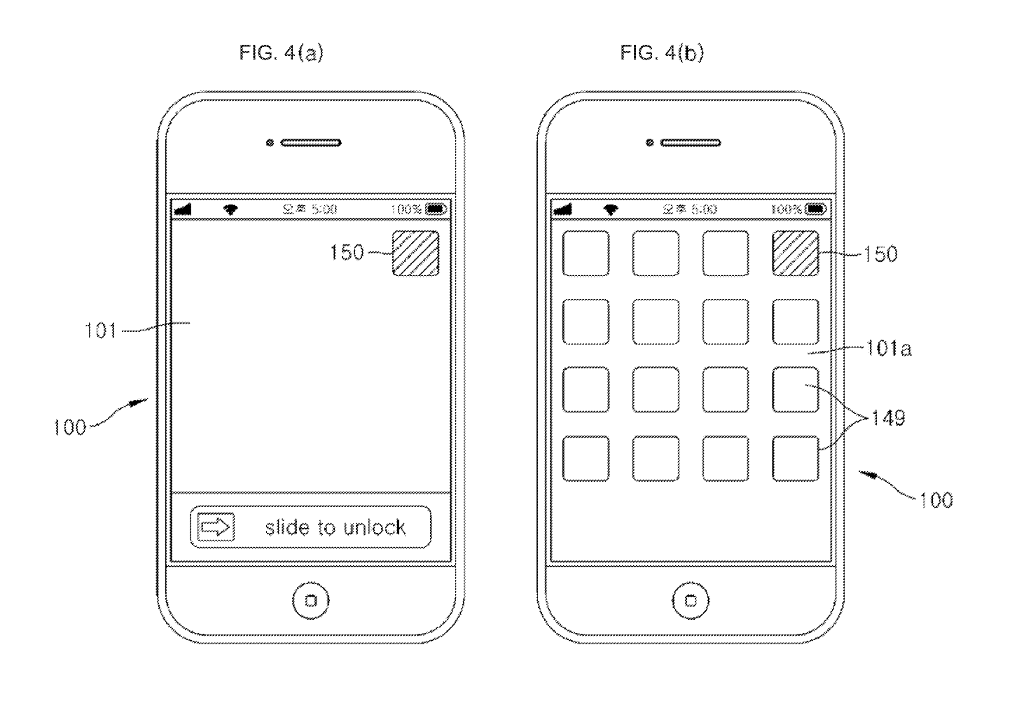

FIG. 4 illustrates two embodiments showing exemplary positions of changing widgets displayed on the user device 100. FIG. 4 is provided as an example only and other implementations are possible in terms of the size, position, or form of the changing widget. FIG. 4A illustrates that the changing widget 150 is displayed on a lock release screen and FIG. 4B illustrates that the changing widget 150 is displayed on a home screen.

As illustrated in FIG. 4A, the changing widget 150 may be arranged on a top of the lock release screen 101. When an input unit is pressed for a smart device that is in a sleep mode, the lock release screen 101 is called as illustrated. In some implementations, the changing widget 150 may be called together with the lock release screen 101. The changing widget may be positioned at a specific position of the lock release screen 101, for example, at an upper part of the lock release screen 101, to change a form, color, or position thereof. In some implementations, in order to be displayed on the upper part of the lock release screen 101, the changing widget application may access a module of operation system software of the user device 100. The changing widget 150 may function as a launcher on the lock release screen 101 to be displayed.

In an embodiment of FIG. 4A, if an input unit generates a touch event to the changing widget 150, following processes can be performed: (1) a process for obtaining a content display area on the lock release screen 101 and displaying pre-registered content at a corresponding content display area, or (2) a process for releasing the lock and moving the pre-registered content to a display screen.

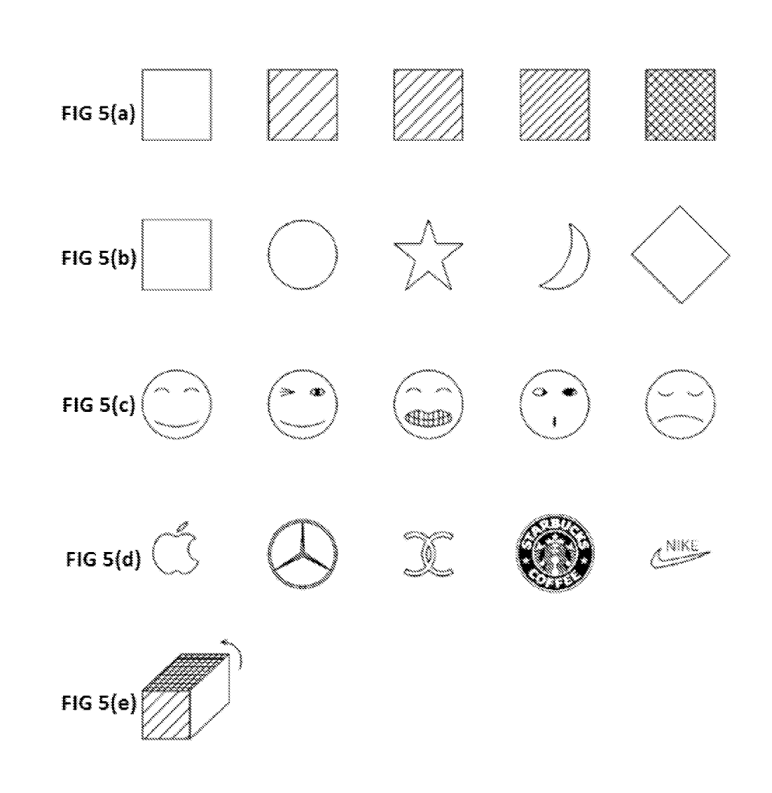

FIG. 4B shows another embodiment that the changing widget 150 may be arranged at a specific position of a home screen 101a of the user device 100. The home screen 101a may have a plurality of pages including a main screen and sub-screens. When the changing widget 150 is present at a sub-screen (for example, a screen visualized only by a touch gesture of the user) rather than a main screen (for example, a screen visualized at the time of the lock release), since a user access is considerably limited, the changing widget 150 may be arranged on the main screen. FIG. 4B shows an example that the changing widget 150 is arranged at the upper part of the main screen. In some implementations, the changing widget 150 may be arranged together with another widgets 149 (for example, icons) on the home screen 101a while being displayed at the upper part of the home screen 101a. In some implementations, the changing widget 150 may be arranged separately from other widgets 149 and installed at a distinguishable position. FIGS. 5A to 5E exemplarily illustrate a changing widget 150 changed in terms of form or color according to various embodiments of the disclosed technology. The changing widget 150 may have various designs. The changing widget 150 may be designed in various manners with an icon formed with a geometric form, color, character, or symbol, or a stereoscopic image displayed on a screen. The design of the changing widget 150 is not particularly limited as long as the changing widget 150 recognizes a selection event, changes a form and/or color of the changing widget 150, and provides pre-registered content to a user screen.

FIG. 5A illustrates that the color of the changing widget is changed (in the drawing, the color change is illustrated with different diagonal lines because of a format of the drawing). The color of the changing widget 150 can change for the display according to a pre-determined rule or randomly while the form of the changing widget 150 is not changed. If a widget having a different color is selected, different content may be displayed. The changing widget of the present embodiment may accompany various visual changes such as a color change or brightness change in color.

FIG. 5B represents an embodiment in which a geometric form of the changing widget positioned on the user screen changes. Such a change in form of the widget indicates a change of content provided by the widget. The drawing shows examples of the change of the geometric form and other various changes can be made. For example, when the changing widget has a balloon shape on the display screen, the change in the geometric form can be implemented by changing the size of the balloon. The embodiment of FIG. 5B may be combined with the embodiment of FIG. 5A.

An embodiment of FIG. 5C shows an embodiment that the changing widget is designed as an emoticon type and is changed to different emoticons. Since the emoticon is a design widely used by users in a computer network, the emoticon may have high availability as a graphic user interface. In the present embodiment, a user can recognize the change of content by a change of the emoticon displayed.

FIG. 5D shows an embodiment in which the changing widget may be configured with a company's logo. The present embodiment provides user's experience that the changing widget may operate as an advertisement medium. Selection of a logo represented by the changing widget enables an access to advertisement content of the company that uses the logo.

An embodiment of FIG. 5E shows a changing widget having a stereoscopic shape. The changing widget may be configured in a 3D image form. In this case, if the stereoscopic shape of the changing widget rotates or the changing widget changes the stereoscopic form, the user can recognize the change of content displayed on the screen.

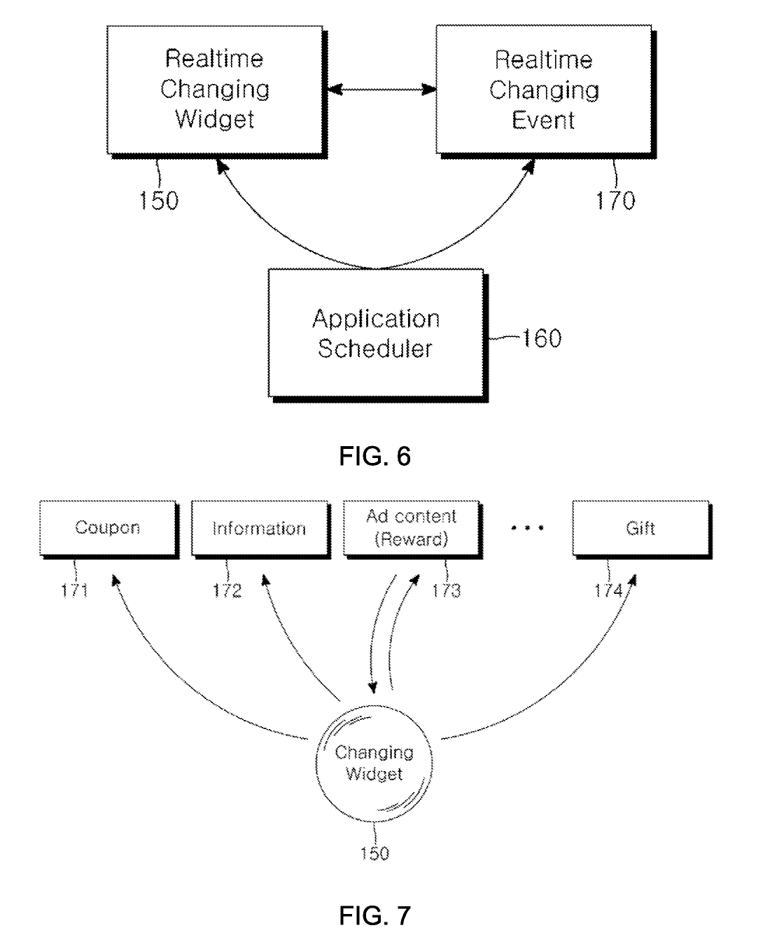

It is appreciated that the above-described various embodiments as shown in FIG. 5A to 5E may be combined to each other, and other modification examples are also possible. For example, a position of the changing widget can be changed. A configuration may include that the changing widget at a specific position, Position 1, on the user screen changes its position to Position 2 on the screen according to scheduling. For example, a position coordinate value on the user screen is changed such that the changing widget positioned at a right upper end moves to a left upper end. Such a position change is also one example of a visible change recognizable by the user. In this case, content provided to the user is changed according to a position change of the changing widget. If the changes shown in FIG. 5, such as form or color are combined with the position change, visibility for a change of the changing widget may become greater. FIG. 6 conceptually illustrates a relationship between the changing widget 150 and the content 170 displayed on the user device. In some implementations, the changing widget application installed in a smart device includes a module of an application scheduler 160. The application scheduler 160 may execute a real time change of the changing widget 150 in accordance with a given schedule. In some implementation, the form, color, and/or position of the changing widget 150 may be changed at every given time interval. In some implementations, position information of the user device is obtained and the form, color, and/or position of the changing widget 150 may be changed based on the position information. In some implementations, the changing widget 150 may be randomly changed.

The changing widget application may provide a user interface for setting a change method of the changing widget 150. In addition, the application server may update a scheduling function of the application scheduler 160. In some implementations, a change of the changing widget 150 may accompany an event of causing the content 170 provided through the changing widget 150 to be changed as well. In other words, the changing widget 150 and the corresponding content 170 mutually have information on a matching relationship. Therefore, it may be understood that the application scheduler 160 performs a scheduling function of the content 170 matched with the changing widget 150. Every time the registered content is changed, the matching relationship thereof will be changed.

FIG. 7 represents various scenarios about relationships between the changing widget 150 and corresponding contents 171, 172, 173, and 174. As described above, the changing widget 150 will display a temporal change of a graphic user interface while changing a form or color in real time. The changing widget 150 may change its form, color, and/or position such that the changing widget 150 is displayed differently. The user will recognize the change of the changing widget 150 and generate a certain selection event for a particular widget during the change of the changing widget 15. Pre-determined content corresponding to the particular widget for which the selection event is made is displayed on a screen.

The user may touch the changing widget 150 displayed on the screen of the user device. In a touch input process, a user's finger tough provides an input. A touch screen senses a touch point at which the touch event occurs. Besides the finger touch, the input can be provided by an input device such as an electronic pen. Referring to FIG. 7, if the selection event is made for the particular widget corresponding to the coupon content 171, “coupon” content 171 may be displayed as a corresponding content on the user screen. The user may download this coupon in a memory for further use of the coupon. The user may use the mobile coupon as a beverage ticket, performance ticket, lodging ticket, refueling ticket, or discount ticket.

The changing widget 150 keeps changing at a regular or random basis. When the changing widget is changed to a different widget corresponding to information content and the selection event is made for the changed widget, “information” content 172 may be displayed as a corresponding content on the user screen. The information content 172 may include news information. In addition, the information content may include text including fortune information, a wise saying, or a proverb, or any other content that can be useful for the user. In other words, information content may include any information page.

Let's assume that the changing widget 150 is changed again to an widget corresponding to advertisement content. If the selection event is made for this widget corresponding to advertisement content, advertisement content 173 may be displayed as a corresponding content on the user screen. The advertisement content may include a video, image, or a link providing an access to a site of an advertiser. In some implementations, an application provides a pre-determined reward for an event executing the advertisement content 173. For this, the application may record the occurrence of the event executing the advertisement content 173 and obtain account information of the smart device to which the reword is sent. Although such a reward model advertisement method is known in the art, there is a limitation to attract users to access advertisement content by providing a simple reward only. Many users tend to disregard the advertisement content even with the reward if they feel not interested enough for the advertisement content. However, in some implementations of the disclosed technology, by changing the widget, a user's curiosity may be induced for what the changing widget 150 contains and by combining a reward concept with the curiosity, there may be more chances for a user to access the advertisement content. Accordingly, the advertisement content can be more spontaneously and easily accessed.

Let's assume that the changing widget 150 is changed again to the changing widget corresponding to gift content 174. If the selection event is made for such changing widget, gift content 174 can be provided on the user screen. The user may download the corresponding gift content 174 and receive the gift.

In some implementations, when the changing widget 150 is selected, a message instead of content can be provided on the user device. For example, if no content is available for the selected changing widget, the message, “sorry, there is nothing at this time” may be popped up.

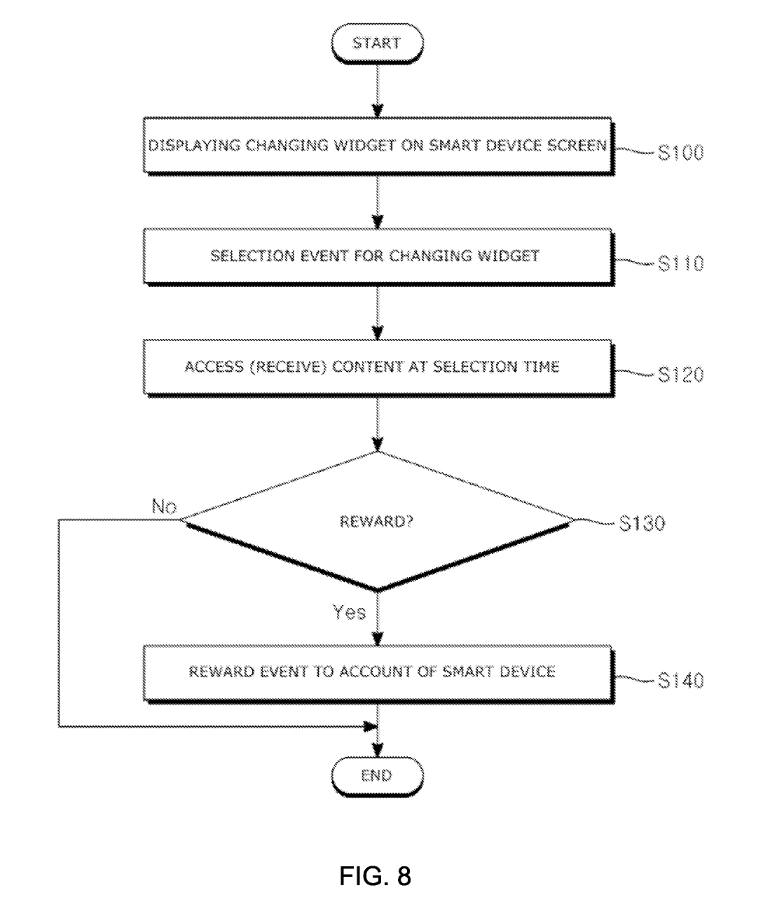

FIG. 8 schematically represents a configuration of an entire process according to an implementation of the disclosed technology. The changing widget application may be installed in the smart device. The user may set an execution environment of the changing widget application. For example, the execution environment may include whether an application is executed, an execution time, or a changing condition of the changing widget.

The smart device displays the changing widget at a specific position of a user screen (operation S100). In some implementations, the changing widget may be displayed on a lock release screen. In some implementations, the changing widget may be displayed on a home screen. It has been explained that the changing widget may change a form, color, and/or position.

An input unit of a smart device generates a selection event for the changing widget (operation S110). For example, a touch event in a mobile device or a remote selection event in a smart TV may occur.

In response to the selection event, content corresponding to the changing widget that is displayed when a selection was made is called (operation S120). The corresponding content may be provided as an output. For example, the corresponding content may be provided on a screen of the user device. In some implementations, the content may be just displayed or the content may be replayed on a screen. In some implementations, a link accessing to the content is provided and the content can be provided through a link.

As described above, some contents simply provide information only. In some implementations, contents may provide monetary compensation to the user. For this, the device may be further configured to determine whether the content specified by the selection event has any related compensation for the selection event (operation S130).

When there is compensation related to the content, a reward event for providing a reward is performed (operation S140). In order to facilitate the rewarding event, recording the reward and obtaining the account information may be executed. A method of providing different contents according to a visibly changed widget on a screen of a user device has been described. The method as discussed above may be implemented in a program instruction type executable through various computer means and recorded on a computer readable recording medium. The computer readable recording medium may include a program instruction, data file, a data structure, or so forth exclusively or by combination. The program instructions recorded on the medium include those designed and configured for implementing various implementations of the disclosed technology, or known to those skilled in the art to be available. In some implementations, a non-transitory computer readable medium storing instructions when executed by a computing device that enable operations as discussed above can be provided.

An example of the computer readable medium includes magnetic media such as a hard disk, floppy disk, and magnetic tape, optical media such as a CO-ROM and DVD, and a magneto-optical media like a floptical disk, and a hardware device specially configured to store and perform program instructions such as a ROM, RAM, and flash memory. An example of a program instruction may include high-level language code executable by a computer using an interpreter in addition to machine code created by a compiler. The hardware device may be configured to operate as at least one software module to perform operations of various embodiments and vice versa.

A computer readable recording medium includes a software module for executing a process as described above. Such a module includes a module displaying a changing widget visibly changed on a user screen of a smart device, a module recognizing a selection event for the changing widget of an input unit of the smart device, and a module calling content corresponding to the selected changing widget to the user screen of the smart device.

In relation to representation of drawing, each block represents a module including one or more executable instructions for executing specific logical function(s), or a part of segment or code. In several replacement execution examples, it is noted that functions referred to in blocks may occur out of a sequence. For example, two blocks illustrated one after the other are possible to be performed substantially at the same time or in a reverse sequence according to functions corresponding to the blocks. Drawings are exaggeratedly illustrated for convenience of explanation.

The protection scope of the disclosed technology in this patent document is not limited to the descriptions and representations of some implementations described above. Various modifications or replacement are also possible within the disclosed technology.

What is claimed is:

1. A method for providing content, the method comprising:
(a) displaying a changing widget on a display unit of a user device, the changing widget being changeable on the display as one of different widgets including a first widget and a second widget that are visually different from one another;
(b) receiving, by an input unit of the user device, an input indicating a selection of one of the different widgets as a selected widget; and
(c) displaying content corresponding to the selected widget on the display unit of the user device.

2. The method of claim 1, wherein the different widgets are visually different from one another in at least one of a form, color, or a position of the widgets.

3. The method of claim 1, wherein the user device includes a smartphone, and the changing widget is displayed on a lock release screen of the display unit.

4. The method of claim 1, wherein the user device includes a smartphone, and the changing widget is displayed on a home screen of the display unit.

5. The method of claim 1, wherein the displayed content changes based at least on the selected widget.

6. The method of claim 1, wherein the first widget and the second widget are associated with different contents from each other.

7. The method of claim 1, wherein the displayed content includes a mobile coupon, an information page, advertisement content, or gift content.

8. The method of claim 1, further comprising: (d) determining whether the displayed content is associated with a reward event and if the obtained content is associated with the reward event, performing the reward event for the user device.

9. The method of claim 1, wherein the user device includes a smartphone, tablet PC, or smart TV.

10. A non-transitory computer readable medium storing instructions when executed by a computing device that enable operations comprising:
displaying a changing widget on a display unit of a user device, the changing widget being changeable on the display as one of different widgets including a first widget and a second widget that are visually different from each other;
receiving, at an input unit of the user device, an input indicating a selection of one of the different widgets as a selected widget; and
displaying content corresponding to the selected widget on the display unit of the user device.

11. A server providing different contents associated with a changing widget, the server comprising:
an application unit providing a changing widget to a user device, the changing widget having a visual appearance changeable as one of different widgets that are different from one another;
a database storing information on the user device and contents associated with the respective different widgets; and
a control unit receiving a request for content from the user device and transmitting, in responsive to the request, content selected from the stored contents in the database to the user device, wherein the received request is associated with a selected widget displayed on the user device and the transmitted content is associated with the selected widget.

12. The system of claim 11, wherein the different widgets are different in terms of at least one of a form, color, or a position of the widgets.

13. The system of claim 11, wherein the content includes a mobile coupon, an information page, advertisement content, gift content, or a message.

14. The system of claim 13, further comprising an advertisement content server configured to provide a reward in response to the request for content from the user device.

15. The system of claim 11, wherein the user device includes a smartphone, tablet PC, or smart TV.

16. An user device providing different contents, the user device comprising:
a processor to execute a changing widget application providing a changing widget and controlling a visual appearance of the changing widget as the changing widget changes among different widgets;
a data storage unit configured to store information associated with the different widgets changeable by the changing widget and information associated with contents corresponding to the different widgets;
an communication unit configured to receive a selection signal for a particular widget among the different widgets of the changing widget; and
a display unit configured to display the corresponding contents to the particular widget.

17. The user device of 16, wherein the different widgets are different in terms of at least one of a form, color, or a position of the widgets.

18. The user device of claim 16, wherein the content includes a mobile coupon, an information page, advertisement content, gift content, or a message.

19. The user device of claim 16, wherein the processor communicatively operates with external servers providing contents.

20. The user device of claim 16, wherein the user device includes a smartphone, tablet PC, or smart TV.
